(19) United States
(12) Patent Application Publication
(10) Pub. No.: US 2010/0175062 A1
(43) Pub. Date: Jul. 8, 2010

(54) METHOD AND SYSTEM FOR FIRMWARE OVER THE AIR (FOTA) SERVICE

(75) Inventor: June Yeob KIM, Daegu Metropolitan City (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/652,101

(22) Filed: Jan. 5, 2010

(30) Foreign Application Priority Data
Jan. 7, 2009 (KR) 10-2009-0001087

(51) Int. Cl. G06F 9/44

(52) U.S. Cl. 717/173

(57) ABSTRACT

A method and system for providing a firmware over a network to update an update engine used for the firmware upgrade purposes in mobile devices. A specific identifier is inserted into a header of the delta file to inform that the delta file contains an upgrade for the update engine. Upon detection of the specific identifier, the mobile device performs an upgrade of the update engine using the delta file.

### CLAIMS OF PRIORITY

This application claims priority to an application entitled

“METHOD AND SYSTEM FOR FIRMWARE OVER THE AIR (FOTA) SERVICE” filed in the Korean Intellectual Property Office on Jan. 7, 2009 and assigned Serial No. 10-2009-0001087, the contents of which are incorporated herein by reference.

### BACKGROUND OF THE INVENTION

1. Field of the Invention

The present invention relates to a firmware upgrade technology for mobile devices and, more particularly, to a method and system for a firmware over the air (FOTA) service which allows upgrade of an update engine used for upgrading firmware in mobile devices.

2. Description of the Related Art

Generally a mobile device operates through firmware. As well known, firmware refers to programming instructions used to control the hardware of a mobile device in operation. Such firmware may often improve and evolve into new versions to provide better performance and debugging. When a new version of specific firmware is developed, users can upgrade the firmware in their mobile devices by using various wired or wireless techniques. One of recently remarkable upgrade techniques is a FOTA service.

FOTA is an acronym for Firmware Over-the-Air service and provides an upgrade of firmware by offering an update package via a wireless network. In a FOTA service, an update package, also referred to as a delta file, is created by the extraction of differences between an old version and a new version of firmware. A mobile device obtains such a delta file through a wireless network and upgrades firmware by replacing modified parts of existing firmware with the delta file.

To execute the above upgrade process, a mobile device may have an update engine. Like firmware, the update engine may be sometimes upgraded for the purpose of debugging, etc. A conventional FOTA service, however, provides a delta file for firmware upgrade only. Therefore, in case where the update engine in a mobile device has unexpected bugs, a conventional FOTA service may be confronted with problems of the update engine failing to upgrade the firmware or cause an error in the middle of upgrade.

### BRIEF SUMMARY OF THE INVENTION

Accordingly, an aspect of the present invention is to address the above-mentioned problems and/or disadvantages and to provide at least the advantages described below.

One aspect of the present invention is to provide a method and system for a firmware over the air (FOTA) service which allows upgrade of an update engine used for upgrading the firmware in mobile devices.

According to another aspect of the present invention, a method for providing a firmware over the air (FOTA) service includes: creating, by a FOTA server, a delta file by selectively inserting a specific identifier into a header of the delta file, wherein the specific identifier indicates that the delta file is for the upgrading an update engine; transmitting, by the FOTA server, the delta file to a mobile device; checking, upon a receipt of the delta file, the header of the delta file; and upgrading, if the header has the specific identifier, the update engine using the delta file.

According to another aspect of the present invention, a system for providing a firmware over the air (FOTA) service includes: a FOTA server configured to create and transmit a delta file, wherein a specific identifier indicative of upgrading an update engine is selectively inserted into a header of the delta file; and a mobile device configured to receive the delta file, check the header of the delta file, and, if the header has the specific identifier, upgrading the update engine using the delta file.

According to another aspect of the present invention, a computer-implemented system for providing an update accessible by a mobile device includes: a server having a communication interface for transmitting and receiving over a network a delta file, wherein a specific identifier is selectively inserted into a header of the delta file to indicate an update for an update engine; and a mobile device, upon a receipt of the delta file, for upgrading the update engine using the delta file when the specific identifier is detected.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a schematic view which illustrates a FOTA service system in accordance with an exemplary embodiment of the present invention.

FIG. 2 is a block diagram which illustrates a configuration of a mobile device in accordance with an exemplary embodiment of the present invention.

FIG. 3 is a view which illustrates a structure of a delta file in accordance with an exemplary embodiment of the present invention.

FIG. 4 is a flow diagram which illustrates a method for a FOTA service in accordance with an exemplary embodiment of the present invention.

### DETAILED DESCRIPTION OF THE INVENTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

Among terms set forth herein, a ‘delta file’ refers to a file created by the extraction of differences between an old version and a new version of firmware for a mobile device. The delta file may also be referred to as an update package. The delta file may include firmware data and address information. The firmware data refers to data extracted as differences between an old version and a new version of firmware. The address information refers to the value of a memory address where firmware data is to be stored.

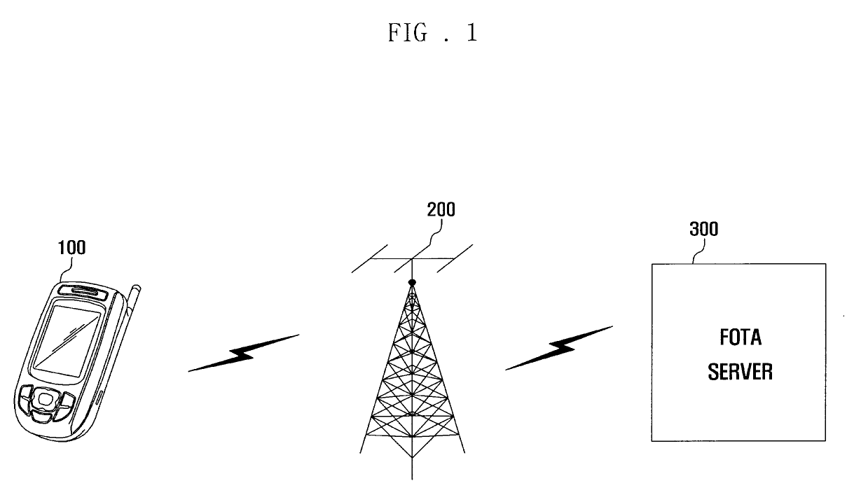

FIG. 1 is a schematic view which illustrates a FOTA service system in accordance with an exemplary embodiment of the present invention.

Referring to FIG. 1, the FOTA service system includes a mobile device 100, a base station 200, and a FOTA server 300.

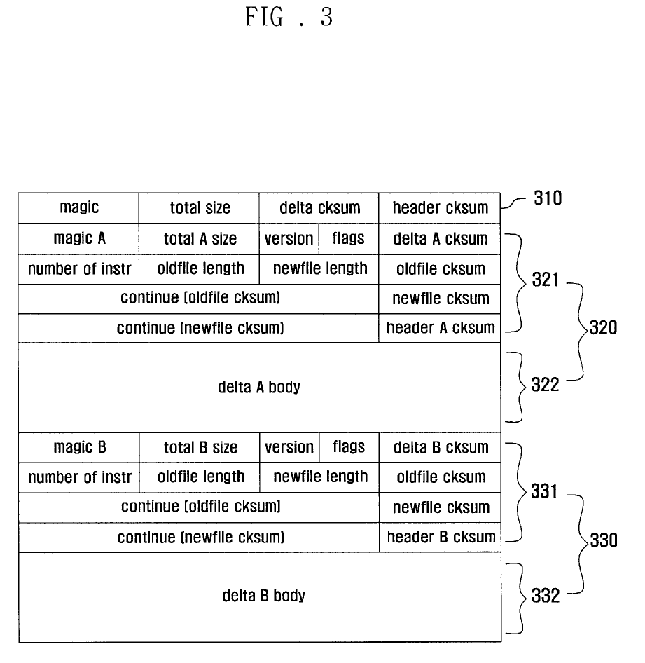

The FOTA server 300 transmits a delta file to the mobile device 100 through the base station 200. A manufacturer of the mobile device 100 may provide such a delta file to the FOTA service 300. Particularly, the FOTA server 300 may insert a specific identifier into a header of the delta file. This identifier informs that the delta file may be used for upgrading an update engine. In addition, the FOTA server 300 may further insert firmware version information into the delta file. This firmware version information enables the FOTA server 300 to recognize the upgrade state of the mobile device. That is, the FOTA server 300 can verify the upgrade state of firmware or the update engine by receiving the version information on firmware from the mobile device 100 during an upgrade mode. Also, the FOTA server 300 may add data necessary for firmware upgrade to the delta file. Then, the FOTA server 300 sends such a delta file to the mobile device 100. A detailed structure of the delta file will be described later with reference to FIG. 3.

The base station 200 establishes a communication channel with the mobile device 100. The base station 200 transmits the delta file to the mobile device 100 through the communication channel after receiving the delta file from the FOTA server 300. Also, the base station 200 receives firmware version information from the mobile device 100 and then sends it to the FOTA server 300.

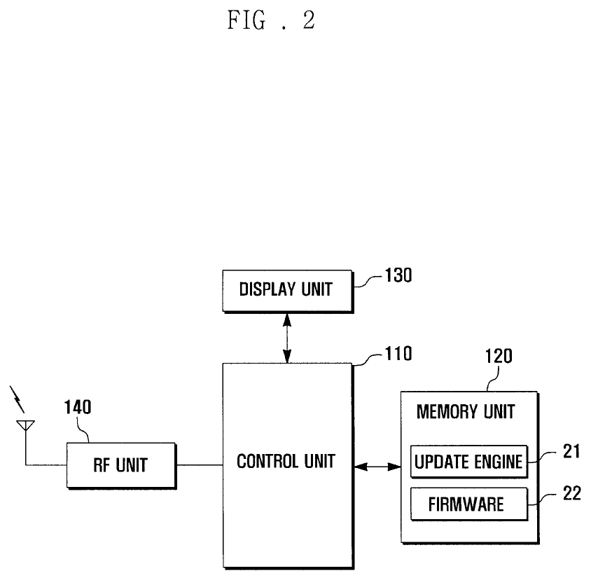

The mobile device 100 is one of wireless communication terminals which allow the upgrades of firmware and update engine. Particularly, the mobile device 100 receives the delta file from the FOTA server 300 through the base station 200 and then upgrades the update engine by using the delta file. If the delta file has firmware version information, the mobile device 100 may also update the firmware version information. Additionally, if the delta file further has data for upgrade of a specific firmware, the mobile device 100 may upgrade the firmware after upgrade of the update engine. After upgrading the firmware or the update engine, the mobile device 100 may send the firmware version information to the FOTA server 300. This is to notify the FOTA server 300 that upgrade is completed without errors. A detailed configuration of the mobile device 100 will be described hereinafter with reference to FIG. 2.

FIG. 2 is a block diagram which illustrates a configuration of a mobile device in accordance with an exemplary embodiment of the present invention.

Referring to FIGS. 1 and 2, the mobile device 100 according to an embodiment of this invention includes a control unit 110, a memory unit 120, a display unit 130, and a radio frequency (RF) unit 140.

The RF unit 140 establishes a communication channel with the base station 200 and performs a voice call, a video telephony call, and a data communication through such a channel. To this end, the RF unit 140 may include an RF transmitter that upwardly converts the frequency of signals to be transmitted and amplifies the signals, and an RF receiver that amplifies received signals with low-noise and downwardly converts the frequency of the received signals. In particular, the RF unit 140 may receive the delta file for upgrading an update engine 21 from the FOTA server 300 through the base station 200. The update engine 21 is used for upgrading a specific firmware 22. The delta file has a header into which a specific identifier is inserted so as to inform that the delta file is for upgrade of the update engine 21. A detailed structure of the delta file will be described later with reference to FIG. 3.

The display unit 130 offers a great variety of information and data on a screen in connection with the state and operation of the mobile device 100. The display unit 130 may be formed of a liquid crystal display (LCD), an organic light emitting diode (OLED), or any other well known equivalent. In some cases the display unit 130 may be a touch screen with an input function. In particular, the display unit 130 according to an embodiment of this invention may represent a pop-up window which indicates that the delta file has been received or indicates that the update engine 21 is being upgraded. Additionally, the display unit 130 may represent in the indicator zone an icon for indicating the reception of the delta file. In an alternative embodiment, the above receiving or upgrading process may be executed as a background processing without being displayed on the display unit 130.

The memory unit 120 stores programs required for controlling a general operation of the mobile device 100. Additionally, the memory unit 120 stores a variety of application programs related to functions of the mobile device 100 and data required for or created during the execution of such functions. In particular, the memory unit 120 according to an embodiment of this invention may store the update engine 21 and the firmware 22.

The firmware 22 may include programming instructions used for operation of the mobile device 100. In particular, the firmware 22 according to an embodiment of this invention may be upgraded after upgrading the update engine 21 if the delta file contains data for upgrading a specific firmware.

The update engine 21 receives the delta file from the FOTA server 300 and upgrades the specific firmware 22 by replacing specified address parts with the delta file. Preferably, the update engine 21 and the firmware 22 may be separately stored at different regions. In particular, the update engine 21 according to an embodiment of this invention may be upgraded through a FOTA service. For this, the delta file may have a specific identifier which is inserted in a header thereof and indicates that the delta file is for upgrading the update engine 21.

The control unit 110 performs an overall control function related to the mobile device and controls the flow of signals between blocks in the mobile device 100. In particular, the control unit 110 according to an embodiment of this invention may detect the reception of the delta file. Additionally, upon receipt of the delta file, the control unit 110 checks version information on the current firmware. If the checked version information is identical to firmware version information stored in the delta file, the control unit 110 may delete the received delta file.

Also, the control unit 110 may check the header of the delta file to determine whether the delta file is for upgrade of the firmware 22 or of the update engine 21. For example, the control unit 110 determines that the delta file is for upgrade of the update engine 21 in case where an identifier in the header is “BPTZ”, and determines that the delta file is for upgrade of the firmware 22 in case where the identifier is “BPDZ”. Thereafter, the control unit 110 may selectively upgrade the update engine 21 or the firmware 22 depending on the identifier.

After upgrading the update engine 21, the control unit 110 may further update the version information on the firmware 22 if the delta file has firmware version information. This is done by checking a current firmware version of the mobile device with the version information on the firmware 22. Update of the firmware version information enables the FOTA server 300 to recognize the upgrade state of the mobile device 100. That is, the control unit 110 may notify the completion of upgrade by sending the firmware version information to the FOTA server 300. Furthermore, the control unit 110 may upgrade the firmware 22 after upgrade of the update engine 21 if the delta file has data for firmware upgrade. Here, the control unit 110 may activate the update engine 21 and may reboot the mobile device 100 to initialize the update engine 21. The control unit 110 may send the firmware version information to the FOTA server 300 after upgrade of the firmware 22.

Although not illustrated, any other elements may be essentially or selectively included in the mobile device of the present invention. For example, the mobile device may further include an input unit, a camera module, a digital broadcast receiving module, a short distance communication module, an Internet access module, and an audio input/output module. Additionally, as will be understood by those skilled in the art, some of the above-discussed elements in the mobile device may be omitted or replaced with another.

Meanwhile, the present invention is not limited to specific types of the mobile device. Many types of electronic devices such as a mobile phone, a PDA, a smart phone, a PMP, a music player, a DMB player, a car navigation system, a game console, and any other kinds of portable or handheld devices may be also employed for the present invention.

FIG. 3 is a view which illustrates a structure of a delta file in accordance with an exemplary embodiment of the present invention.

Referring to FIG. 3, the delta file according to an embodiment of this invention includes a header 310, an engine upgrade part 320, and a firmware upgrade part 330.

The header 310 is a part to record the type, the size, and error correction information of the delta file. Specifically, the header 310 includes an identifier section (magic) to record the type of the delta file, a size section (total size) to record the size of the delta file, a delta file error correction section (delta cksum) to record error correction information about the delta file, and a header error correction section (header cksum) to record error correction information about the header. The header 310 has 16 bytes in total, and each section has 4 bytes. For example, if the delta file is for upgrade of the update engine 21, the identifier section (magic) of the header 310 records “BPTZ”.

The engine upgrade part 320 is a part to record information about upgrade of the update engine 21. The engine upgrade part 320 is composed of a first header 321 and a first body 322. The first header 321 of 64 bytes includes a data kind (magic A), a data size (total A size), version information (version), etc. The first body 322 has data necessary for upgrade of the update engine 21. The data kind (magic A) of the engine grade part 320 records a specific identifier (e.g., “BPEZ”) to inform that the engine upgrade part 320 is for upgrade of the update engine 21. Since the structure of the engine upgrade part 320 complies with the FOTA standards, a more detailed description thereof will be omitted to avoid redundancy.

The firmware upgrade part 330 is a part to record information about upgrade of the firmware 22. The firmware part 320 is composed of a second header 331 and a second body 332. The second header 331 of 64 bytes includes a data kind (magic B), a data size (total B size), version information (version), etc. The second body 332 has data necessary for upgrade of the firmware 22. The data kind (magic B) of the firmware part 330 records a specific identifier (e.g., “BPDZ”) to inform that the firmware upgrade part 330 is for upgrade of the firmware 22. Since the structure of the firmware upgrade part 330 complies with the FOTA standards, a more detailed description thereof will be omitted to avoid redundancy.

As discussed above, if the header 310 of the received delta file contains “BPTZ”, the mobile device 100 considers that the delta file is for upgrade of the update engine 21. Also, the mobile device 100 checks the respective data kinds (magic A, magic B) of the engine upgrade part 320 and the firmware upgrade part 330. Then, upgrade of the update engine 21 is performed depending on data and address information contained in a certain part with the data kind of “BPEZ”. Similarly, upgrade of the firmware 22 is performed depending on data and address information contained in a certain part with the data kind of “BPDZ”. In case of upgrading the update engine 21 only, the firmware upgrade part 330 of the delta file may be filled with meaningless data (e.g., “00000000000000 . . . ”). Alternatively, the firmware upgrade part 330 of the delta file may have firmware version information only.

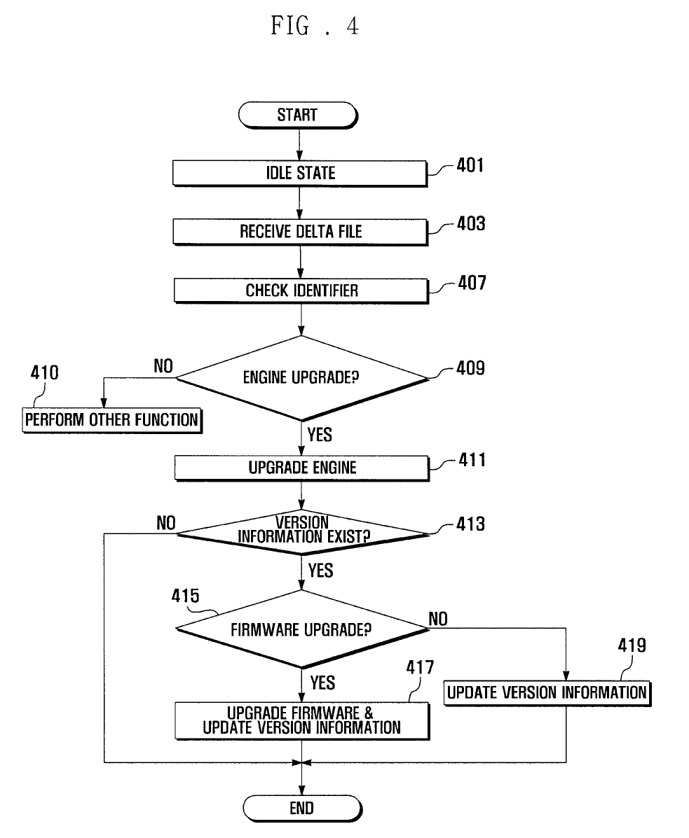

FIG. 4 is a flow diagram which illustrates a method for a FOTA service in accordance with an exemplary embodiment of the present invention.

Referring to FIGS. 2 and 4, at the outset, the mobile device 100 is in an idle state (step 401). Then the mobile device 100 receives the delta file from the FOTA server 300 (step 403). The delta file will be used to upgrade at least one of the firmware 22 and the update engine 21. In particular, the delta file of this invention is used for upgrade of the update engine 21. For this, the delta file has a specific identifier which is inserted in a header thereof which indicates that the delta file is for upgrade of the update engine 21. This identifier is “BPTZ”, for example, but other notations can be used to indicate the same message.

Next, the control unit 110 checks the header of the delta file (step 407). By performing the step 407, the control unit 110 can determine whether the delta file is for upgrade of the update engine 21 (step 409). For example, if an identifier in the header is “BPTZ”, the control unit 110 determines that the delta file is for upgrading the update engine 21. Here, by checking the respective data kinds (magic A, magic B) of the engine upgrade part 320 and the firmware upgrade part 330, the control unit 110 may determine that a part with the data kind of “BPEZ” is for upgrade of the update engine 21 and a part with the data kind of “BPDZ” is for upgrade of the firmware 22.

If the delta file is not for upgrade of the update engine 21 as the result of determination in the above step 409, the control unit 110 performs other function (step 410). For example, if the delta file has an identifier indicating firmware upgrade, the control unit 110 upgrades the firmware 22 by using a conventional upgrade technique. If it is determined in the above step 409 that the delta file is for upgrade of the update engine 21, the control unit 110 performs upgrade of the update engine 21 (step 411).

Next, the control unit 110 determines whether there is firmware version information in the delta file (step 413). If there is no firmware version information, the FOTA service process is ended. If the delta file has the firmware version information, the control unit 110 further determines whether the delta file has data for firmware upgrade (step 415). If there is data for firmware upgrade, the control unit 110 not only upgrades the firmware 22, but also updates the firmware version information (step 417). Here, the control unit 110 may activate the update engine 21 and may reboot the mobile device 100 to initialize the update engine 21.

If it is determined in the above step 415 that there is no data for firmware upgrade, the control unit 110 performs only update of the firmware version information (step 419). The reason that the firmware version information is updated is that the FOTA server 300 recognizes the upgrade state of the mobile device 100 by checking the firmware version information. If the firmware version information is not updated, the FOTA server 300 may not know the upgrade state of the mobile device 100.

As discussed above, if there is a need to upgrade the update engine 21, the FOTA server 300 creates the delta file by inserting a specific identifier for informing upgrade of the update engine 21 into the header of the delta file. The mobile device 100 receives the delta file from the FOTA server 300 and performs upgrade of the update engine 21 by using the delta file.

In addition, the FOTA server 300 may insert data necessary for update of firmware version information into the delta file. This is to verify that the update engine 21 is upgraded without errors. That is, the FOTA server 300 can verify the upgrade state of the mobile device 100 by checking the firmware version information.

Meanwhile, if there is a need to upgrade the firmware 22, the FOTA server 300 may further insert data necessary for upgrade of the firmware 22 into the delta file for upgrade of the update engine 21. Upon receiving this delta file, the mobile device 100 upgrades the update engine 21 by checking the header of the delta file, and also, upgrades the firmware 22 by using relevant data.

As fully discussed heretofore, the FOTA service method and system of the present invention allow upgrade of the update engine used for upgrading the firmware in mobile devices. Therefore, this may effectively solve the prior art problems of update engine failing to upgrade the firmware due to its unexpected bugs or makes an error in the middle of upgrade.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A method for providing a firmware over the air (FOTA) service, the method comprising:
creating, by a FOTA server, a delta file by selectively inserting a specific identifier into a header of the delta file, wherein the specific identifier indicates that the delta file is for upgrading an update engine;
transmitting, by the FOTA server, the delta file to a mobile device;
checking, upon a receipt of the delta file, the header of the delta file; and
upgrading, if the header includes the specific identifier, the update engine using the delta file.

2. The method of claim 1, wherein the creating the delta file includes one of:
adding a firmware version information to the delta file; and
adding both the firmware version information and data used for upgrading the firmware.

3. The method of claim 2, further comprising: if the delta file has the firmware version information only, upgrading the firmware version information after upgrading the update engine.

4. The method of claim 2, further comprising: if the delta file has both the firmware version information and the data used for upgrading the firmware, updating the firmware version information and upgrading the firmware after upgrading the update engine.

5. The method of claim 1, wherein, upon the receipt of the delta file, checking version information on a current firmware of the mobile device; and deleting the delta file if the current version information is identical to the firmware version information in the delta file.

6. The method of claim 1, further comprising: displaying at least a portion of the mobile device with a progress of upgrading the firmware and the update engine.

7. The method of claim 1, further comprising notifying, by the mobile device, a completion of upgrading the update engine to the FOTA server.

8. A system for providing a firmware over the air (FOTA) service, comprising:
a FOTA server configured to create and transmit a delta, wherein a specific identifier indicative of upgrading an update engine is selectively inserted into a header of the delta file; and
a mobile device configured to receive the delta file, check the header of the delta file, and, if the header has the specific identifier, upgrading the update engine using the delta file.

9. The system of claim 8, wherein the FOTA server is further configured to add a firmware version information to the delta file, or add both the firmware version information and data for upgrading the firmware.

10. The system of claim 8, wherein the mobile device includes:
a radio frequency unit configured to receive the delta file; and
a control unit configured to check the header of the delta file, and, if the header has the specific identifier, upgrading the update engine.

11. The system of claim 10, wherein the control unit is further configured to, if the delta file has the firmware version information only, updating the firmware version information after upgrading the update engine.

12. The system of claim 10, wherein the control unit is further configured to, if the delta file has both the firmware version information and the data for upgrading the firmware, updating the firmware version information and upgrading the firmware after upgrading the update engine.

13. The system of claim 10, wherein the control unit is further configured to check version information on a current firmware of the mobile device, and delete the delta file if the checked version information is identical to the firmware version information of the delta file.

14. The system of claim 9, wherein the firmware and the update engine are stored separately in the mobile device.

15. The system of claim 8, wherein the mobile device transmits a signal indicative of a completion of upgrading the update engine to the FOTA server.

16. A computer-implemented system for providing an update accessible by a mobile device, comprising:
a server having a communication interface for transmitting and receiving over a network a delta file, wherein a specific identifier is selectively inserted into a header of the delta file to indicate an update for an update engine; and a mobile device, upon a receipt of the delta file, for upgrading the update engine using the delta file when the specific identifier is detected.

17. The system of claim 16, wherein the server is further configured to add a firmware version information to the delta file, or add both the firmware version information and data for upgrading the delta file.

18. The system of claim 17, wherein, if the delta file has the firmware version information only, updating the firmware version information after upgrading the update engine.

19. The system of claim 17, wherein, if the delta file has both the firmware version information and the data for upgrading the firmware, updating the firmware version information and the firmware after upgrading the update engine.

20. The system of claim 17, wherein deleting the delta file if a current firmware version information of the mobile device is identical to the firmware version information of the delta file.

21. The system of claim 16, wherein the mobile device transmits a signal indicative of a completion of upgrading the update engine to the server.
